(19) United States
(12) Patent Application Publication
(10) Pub. No.: US 2025/0135753 A1
(43) Pub. Date: May 1, 2025

(54) Transparent Display

(71) Applicant: Pittsburgh Glass Works, LLC, Cheswick, PA (US)

(72) Inventor: Kyle Fragassi, Pittsburgh, PA (US)

(21) Appl. No.: 18/926,267

(22) Filed: Oct. 24, 2024

Related U.S. Application Data
(60) Provisional application No. 63/545,868, filed on Oct. 26, 2023.

(51) Int. Cl. B32B 17/10; B32B 27/30; B32B 27/40; B32B 37/06; B32B 37/10; H01L 25/075; H01L 25/16

(52) U.S. Cl. CPC B32B 17/10541; B32B 17/10036; B32B 17/10761; B32B 17/10871; B32B 17/10935; B32B 17/10972; B32B 2307/7376; B32B 2457/208; B32B 2605/006

(57) ABSTRACT

An article includes: a first substrate including a No. 1 surface and a No. 2 surface opposite the No. 1 surface; and a microLED display system positioned to project light towards the No. 2 surface. The article may be a laminated glass article. Automobiles including the articles are also disclosed. Methods for manufacturing a laminated glass article are also disclosed.

### CROSS-REFERENCE TO RELATED APPLICATION

This application claims the benefit of U.S. Provisional Patent Application No. 63/545,868, filed Oct. 26, 2023, the disclosure of which is hereby incorporated by reference in its entirety.

### BACKGROUND

### Field

The present application relates generally to glass articles and, more specifically, to transparent displays and associated methods for manufacturing transparent displays.

### Technical Considerations

Displays, such as reflective or emissive displays, commonly used for personal electronic devices, such as e-readers and tablets, may be useful in other applications to share information. Glass, while on its own is passive, has potential for actively displaying information in various architectural and automotive applications. Drawbacks to current materials used to manufacture glass articles, such as laminated glass articles, and more particularly automotive grade glass windows, include high temperatures required to process the materials. The temperatures required for curing and processing materials commonly used in laminated glass articles, particularly automotive grade glass windows, would likely damage displays, such as transparent displays.

Accordingly, those skilled in the art continue research and development in the field of transparent displays and associated methods for manufacturing transparent displays.

### SUMMARY

Disclosed are articles.

In one example, an article includes: a first substrate comprising a No. 1 surface and a No. 2 surface opposite the No. 1 surface; and a microLED display system positioned to project light towards the No. 2 surface.

Also disclosed are laminated glass articles.

In an example, a laminated glass article includes: a first glass substrate comprising a No. 1 surface and a No. 2 surface opposite the No. 1 surface; a second glass substrate opposed from the first glass substrate, where the second glass substrate comprises a No. 3 surface that faces towards the No. 2 surface, and a No. 4 surface opposite the No. 3 surface; a middle interlayer positioned between the first glass substrate and the second glass substrate, the middle interlayer defining an opening configured to receive a microLED display system; the microLED display system positioned in the opening of the middle interlayer and between the No. 2 surface and the No. 3 surface; a first interlayer positioned between the first glass substrate and the middle interlayer; and a second interlayer positioned between the second glass substrate and the middle interlayer.

Also disclosed are automobiles.

In an example, an automobile includes: a window or windshield having a first substrate comprising a No. 1 surface and a No. 2 surface opposite the No. 1 surface; and a microLED display system positioned to project light towards the No. 2 surface.

Also disclosed are methods for manufacturing a laminated glass article.

In an example, the method includes: shaping a first glass substrate comprising a No. 1 surface and a No. 2 surface, and a second glass substrate comprising a No. 3 surface and a No. 4 surface; optionally positioning a first interlayer against the No. 2 surface; positioning a middle interlayer against the first interlayer, wherein the middle interlayer comprises an opening configured to receive a microLED display system; positioning the microLED display system in the opening; optionally positioning a second interlayer between the middle interlayer the No. 3 surface, and between the microLED display system and the No. 3 surface, wherein the first glass substrate, second glass substrate, optional first interlayer, middle interlayer, microLED display system and optional second interlayer form a stacked article; removing air from the stacked article by pulling a vacuum for a predetermined period of time; heating the stacked article after the air has been removed to a temperature between approximately 200° F. and approximately 300° F. for a second predetermined period of time; heating the stacked article to a second temperature between approximately 200° F. and approximately 300° F. for a third predetermined period of time; and subjecting the stacked article to a pressure between approximately 150 PSI and approximately 250 PSI for a fourth predetermined period of time.

This disclosure is further described in the following numbered clauses:

Clause 1: An article comprising: a first substrate comprising a No. 1 surface and a No. 2 surface opposite the No. 1 surface; and a microLED display system positioned to project light towards the No. 2 surface.

Clause 2: The article of clause 1, wherein the first substrate is tempered glass.

Clause 3: The article of clause 1 or clause 2, wherein the microLED display system is coupled with the first substrate.

Clause 4: The article of any of clauses 1-3, wherein the microLED display system has a thickness of approximately 0.1 mm to approximately 0.8 mm.

Clause 5: The article of any of clauses 1-4, wherein the microLED display system has a display size of about 1″ to about 30″.

Clause 6: The article of any of clauses 1-5, wherein the microLED display system comprises a plurality of monochrome microLEDs.

Clause 7: The article of any of clauses 1-6, wherein the microLED display system comprises a plurality of red microLEDs.

Clause 8: The article of any of clauses 1-7, wherein microLED display system comprises a plurality of blue microLEDs.

Clause 9: The article of any of clauses 1-8, wherein the microLED display system comprises a plurality of green microLEDs.

Clause 10: The article of any of clauses 1-9, wherein the microLED display system comprises approximately 50 to approximately 150 PPI.

Clause 11: The article of any of clauses 1-10, further comprising a second substrate opposed from the first substrate, wherein the second substrate comprises a No. 3 surface that faces towards the No. 2 surface, and a No. 4 surface opposite the No. 3 surface, and wherein the microLED display system is positioned between the No. 2 surface and the No. 3 surface.

Clause 12: The article of any of clauses 1-11, further comprising a first interlayer positioned against the No. 2 surface and positioned between the first substrate and the microLED display system.

Clause 13: The article of any of clauses 1-12, further comprising a switchable layer positioned between the first substrate and the MicroLED display system.

Clause 14: The article of clause 12, further comprising a switchable layer positioned between the first interlayer and the microLED display system.

Clause 15: The article of clause 13 or 14, wherein the switchable layer comprises a polymer-dispersed liquid crystal layer and/or an electrochromic layer.

Clause 16: The article of any of clauses 1-15 further comprising a middle interlayer comprising an opening configured to receive the microLED display system.

Clause 17: The article of clause 16, wherein the opening is positioned in a central portion of the middle interlayer.

Clause 18: The article of clause 16, wherein the opening is positioned adjacent to an edge portion of the middle interlayer.

Clause 19: The article of any of clauses 16-18, wherein the middle interlayer has a thickness of approximately 0.25 mm to approximately 0.8 mm.

Clause 20: The article of any of clauses 16-19, wherein the middle interlayer comprises polyurethane or polyvinyl butyral.

Clause 21: The article of clause 11, wherein at least one of the first substrate and the second substrate comprises soda lime glass.

Clause 22: The article of clause 11, further comprising a painted portion positioned over at least a portion of the first substrate or the second substrate, wherein the painted portion covers an area associated with an electronic component associated with the microLED display system.

Clause 23: The article of clause 11, further comprising: a second interlayer positioned between the No. 3 surface and the microLED display system.

Clause 24: The article of any of clauses 11-23, further comprising a switchable layer positioned between the second substrate and the microLED display system.

Clause 25: The article of clause 23, further comprising a switchable layer positioned between the second interlayer and the microLED display system.

Clause 26: The article of clause 25, further comprising a capacitive touch layer positioned between the first interlayer and the microLED display system.

Clause 27: The article of clause 24 or 25, wherein the switchable layer comprises a polymer-dispersed liquid crystal layer and/or an electrochromic layer.

Clause 28: The article of clause 23, wherein at least one of the first interlayer and the second interlayer comprises polyurethane or polyvinyl butyral.

Clause 29: The article of clause 12, wherein the first interlayer has a thickness of approximately 0.25 mm to approximately 0.7 mm.

Clause 30: The article of clause 23, wherein the second interlayer has a thickness of approximately 0.25 mm to approximately 0.7 mm.

Clause 31: The article of clause 12, further comprising a functional layer positioned between the first interlayer and the No. 2 surface.

Clause 32: The article of any of clauses 1-31, wherein the article is a laminated glass article.

Clause 33: The article of clause 32, wherein the laminated glass article is an automobile component.

Clause 34: The article of clause 23, wherein at least one of the first substrate and the second substrate defines a cavity configured to receive at least one electronic connector.

Clause 35: The article of any of clauses 1-34, further comprising an electronic component comprising an electronic connector coupled to the microLED display system.

Clause 36: A laminated glass article comprising: a first glass substrate comprising a No. 1 surface and a No. 2 surface opposite the No. 1 surface; a second glass substrate opposed from the first glass substrate, wherein the second glass substrate comprises a No. 3 surface that faces towards the No. 2 surface, and a No. 4 surface opposite the No. 3 surface; a middle interlayer positioned between the first glass substrate and the second glass substrate, the middle interlayer defining an opening configured to receive a microLED display system; the microLED display system positioned in the opening of the middle interlayer and between the No. 2 surface and the No. 3 surface; a first interlayer positioned between the first glass substrate and the middle interlayer; and a second interlayer positioned between the second glass substrate and the middle interlayer.

Clause 37: An automobile comprising: a window or windshield comprising first substrate comprising a No. 1 surface and a No. 2 surface opposite the No. 1 surface; and a microLED display system positioned to project light towards the No. 2 surface.

Clause 38: The automobile of clause 37, wherein the laminated article is a sidelight.

Clause 39: The automobile of clause 37 or clause 38, further comprising: a second substrate opposed from the first substrate, wherein the second substrate comprises a No. 3 surface that faces towards the No. 2 surface, and a No. 4 surface opposite the No. 3 surface; a middle interlayer positioned between the first substrate and the second substrate, the middle interlayer defining an opening configured to receive the microLED display system; the microLED display system positioned in the opening of the middle interlayer and between the No. 2 surface and the No. 3 surface; a first interlayer positioned between the first substrate and the middle interlayer; and a second interlayer positioned between the second substrate and the middle interlayer.

Clause 40: The automobile of clause 39, wherein the laminated article is a windshield.

Clause 41: A method for manufacturing a laminated glass article comprising shaping a first glass substrate comprising a No. 1 surface and a No. 2 surface, and a second glass substrate comprising a No. 3 surface and a No. 4 surface; optionally positioning a first interlayer against the No. 2 surface; positioning a middle interlayer against the first interlayer, wherein the middle interlayer comprises an opening configured to receive a microLED display system; positioning the microLED display system in the opening; optionally positioning a second interlayer between the middle interlayer the No. 3 surface, and between the microLED display system and the No. 3 surface, wherein the first glass substrate, second glass substrate, optional first interlayer, middle interlayer, microLED display system and optional second interlayer form a stacked article; removing air from the stacked article by pulling a vacuum for a predetermined period of time; heating the stacked article after the air has been removed to a temperature between approximately 200° F. and approximately 300° F. for a second predetermined period of time; heating the stacked article to a second temperature between approximately 200° F. and approximately 300° F. for a third predetermined period of time; and subjecting the stacked article to a pressure between approximately 150 PSI and approximately 250 PSI for a fourth predetermined period of time.

Clause 42: The method of clause 41, further comprising positioning the stacked article in an autoclave.

Clause 43: The method of clause 41 or clause 42, wherein the one or more of the first interlayer, the second interlayer, and the middle interlayer comprises polyurethane.

Clause 44: The method of any of clauses 41-43, wherein the one or more of the first interlayer, the second interlayer, and the middle interlayer comprises polyvinyl butyral.

Clause 45: The method of any of clauses 41-44, wherein the predetermined period of time is about 10 minutes to about 30 minutes.

Clause 46: The method of any of clauses 41-45, wherein the second predetermined period of time is about 15 minutes to about 45 minutes.

Clause 47: The method of any of clauses 41-46, wherein the third predetermined period of time is about 20 minutes to about 40 minutes.

Clause 48: The method of any of clauses 41-47, wherein the fourth predetermined period of time is approximately the same as the third predetermined period of time.

Clause 49: The method of any of clauses 41-48, wherein the temperature is between approximately 220° F. and approximately 260° F.

Clause 50: The method of any of clauses 41-49, wherein the second temperature is between approximately 220° F. and approximately 290° F.

Clause 51: The method of any of clauses 41-50, wherein the heating and the subjecting are performed concurrently.

Other examples will become apparent from the following detailed description, the accompanying drawings, and the appended claims.

### BRIEF DESCRIPTION OF THE DRAWINGS

The disclosure will be described with reference to the following drawing figures wherein like reference numbers identify like parts throughout.

FIG. 1 is a front cross-sectional schematic (not to scale) of an article according to one aspect of the present disclosure;

FIG. 2 is a top cross-sectional view (not to scale) of an article according to another aspect of the present disclosure;

FIG. 3 is a top cross-sectional view (not to scale) of an article according to another aspect of the present disclosure;

FIG. 4 is an exploded isometric view (not to scale) of an article according to another aspect of the present disclosure;

FIG. 5 is a top cross-sectional view (not to scale) of an article according to another aspect of the present disclosure;

FIG. 6 is a top cross-sectional view (not to scale) of an article according to another aspect of the present disclosure;

FIG. 7 is a top cross-sectional view (not to scale) of a laminated glass article according to another aspect of the present disclosure;

FIG. 8 is a perspective schematic (not to scale) of an automobile according to another aspect of the present disclosure; and

FIG. 9 is a flow chart of a method for manufacturing a laminated glass article according to another aspect of the present disclosure.

### DETAILED DESCRIPTION

As used herein, spatial or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about”. Accordingly, unless indicated to the contrary, the numerical values set forth in the following specification and claims may vary depending upon the desired properties sought to be obtained by the present disclosure. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, “coupled”, “coupling”, and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase “at least one of”, when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations.

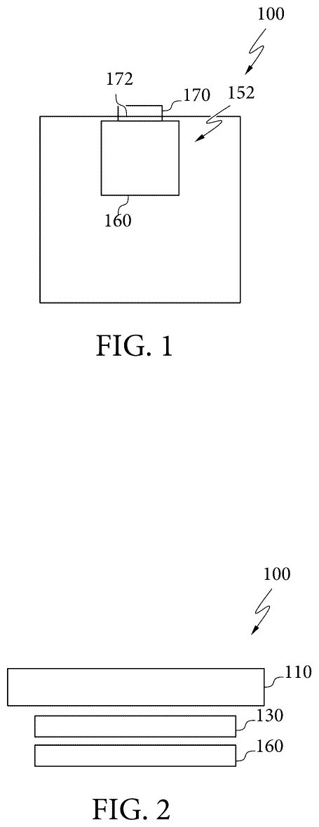

Referring to FIG. 1, disclosed is an article 100. The article 100 may be used for architectural applications or may be laminated for use in locomotive applications, such as in automobiles. Referring to FIG. 2, the article 100 includes a first substrate 110 comprising a No. 1 surface and a No. 2 surface opposite the No. 1 surface. The first substrate 110 may include a material suitable for automotive applications. For example, the first substrate 110 may include glass, such as tempered glass and/or clear soda lime glass.

Referring to FIGS. 1 and 2, the glass article 100 includes a display system 160. The display system 160 may be a microLED display system 160. A “microLED display” or “microLED display system”, as used herein, is any display including one or more microLEDs that form the pixel elements of the display. A “microLED”, as used herein, is a light emitting diode having at least one dimension on the micrometer scale (i.e., less than 100 micrometers). The microLED display system 160 may be positioned so as to project light towards the No. 2 surface of the first substrate 110. In some non-limiting embodiments, the microLED display system 160 may be coupled to the first substrate 110, such as coupled to the No. 2 surface of the first substrate 110. The microLED display system 160 may have a thickness of at least 0.1 mm, or at least 0.2 mm, or at least 0.3 mm, or at least 0.4 mm, or at least 0.5 mm. The microLED display system 160 may have a thickness of up to 0.8 mm, or up to 0.7 mm, or up to 0.6 mm, or up to 0.5 mm. The microLED display system 160 may have a thickness from 0.1 mm to 0.8 mm, or from 0.1 mm to 0.7 mm, or 0.1 mm to 0.6 mm, or from 0.2 mm to 0.7 mm, or from 0.3 mm to 0.6 mm, or from 0.4 mm to 0.6 mm.

The microLED display system 160 may have a display size of a specific size. The microLED display system 160 may have a display size of at least 1″, or at least 2″, or at least 5″, or at least 10″, or at least 15″. The microLED display system 160 may have a display size of up to 30″, or up to 25″, or up to 20″ or up to 15″. The microLED display system 160 may have a display size of from 1″ to 30″, or from 2″ to 25″, or from 5″ to 25″, or from 10″ to 20″. As used herein, “display size” is the length of the diagonal of the display measured from opposite corners of the display. The microLED display system 160 may include a specific number of pixels per inch (PPI). The microLED display system 160 may include at least 50 PPI, or at least 60 PPI, or at least 70 PPI, or at least 80 PPI, or at least 90 PPI. The microLED display system 160 may include up to 150 PPI, or up to 140 PPI, or up to 130 PPI, or up to 120 PPI, or up to 110 PPI. The microLED display system 160 may include from 50 PPI to 150 PPI, or from 60 PPI to 140 PPI, or from 70 PPI to 130 PPI, or from 80 PPI to 120 PPI, or from 90 PPI to 110 PPI.

The microLED display system 160 may include a plurality of microLEDs. For example, the microLED display system 160 may include a plurality of monochrome microLEDs, red microLEDs, blue microLEDs, green microLEDS, or a combination thereof. The microLED display system 160 may include a substrate, such as a glass substrate, having conductive wires configured to deliver power to the microLED(s). The microLED display system 160 may be passively-driven or actively-driven.

A microLED display system 160 that is actively-driven may provide a brighter display and lower power consumption compared to passively-driven displays. This is due to increased current driving capacities.

Referring to FIG. 2, the article 100 may include a first interlayer 130. The first interlayer 130 may be positioned against the No. 2 surface of the first substrate 110. The first interlayer 130 may be positioned between the first substrate 110 and the microLED display system 160. The first interlayer 130 may include a polymeric material, such as polyurethane, ethylene vinyl acetate, polyvinyl butyral, or a combination thereof. For example, the first interlayer 130 may include polyvinyl butyral. The first interlayer 130 may be any thickness required for the intended application. In one example, the first interlayer 130 has a thickness of about 0.25 mm to about 0.7 mm, or about 0.3 mm to about 0.6 mm.

In some non-limiting embodiments, the microLED display system 160 and optional first interlayer 130 may be positioned over the entire No. 2 surface of the first substrate 110. In some non-limiting embodiments, the microLED display system 160 and optional first interlayer 130 may be positioned over only a first portion of the No. 2 surface of the first substrate 110 and absent over a second portion of the No. 2 surface of the first substrate 110.

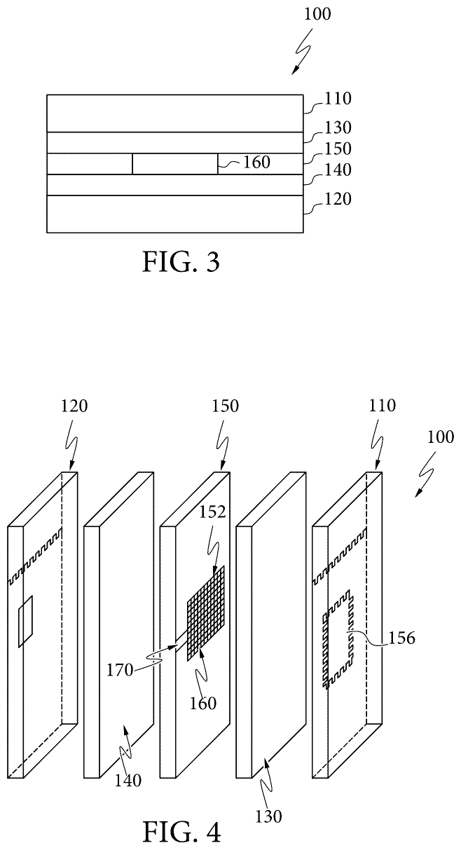

Referring to FIG. 3, the article 100 may further include a second substrate 120. The second substrate 120 may be opposed from the first substrate 110. The second substrate 120 may include a No. 3 surface that faces toward the No. 2 surface of the first substrate 110, and a No. 4 surface opposite the No. 3 surface. When the second substrate 120 is present, the microLED display system 160 may be positioned between the No. 2 surface of the first substrate 110 and the No. 3 surface of the second substrate 120. The first substrate 110 may include a material suitable for automotive applications. For example, the first substrate 110 may include glass, such as tempered glass and/or clear soda lime glass.

The article 100 may further include a middle interlayer 150. The middle interlayer 150 may include an opening 152 configured to receive the microLED display system 160. In one example, the opening 152 is positioned in a central portion of the middle interlayer 150. In another example, the opening 152 is positioned adjacent to an edge portion of the middle interlayer 150. The middle interlayer 150 may be a thickness required for the intended application. For example, the middle interlayer 150 may have a thickness of 0.25 mm to 0.8 mm, or 0.4 mm to 0.7 mm. The middle interlayer 150 may include any polymeric material compatible with the intended use. The middle interlayer 150 may include polyurethane, ethylene vinyl acetate, polyvinyl butyral, or some combination thereof. For example, the middle interlayer 150 may include polyvinyl butyral.

The middle interlayer 150 may include small voids of about 1 mm on the tail edge of the microLED display system 160 to assist lining up an electronic component 170. The middle interlayer 150 may further include an approximately 3 mm overlap or tolerance between the microLED display system 160 and the middle interlayer 150 along the perimeter of the opening 152 to allow for variation in the sizing of the microLED display system 160. An advantage to the overlap is to further reduce a user from seeing the inactive area of the microLED display system 160 from an angle. The microLED display system 160 may have an active area of about 155×115 mm, or 149×109 mm with no do pattern.

The article 100 may include a second interlayer 140. The second interlayer 140 may be positioned between the No. 3 surface of the second substrate 120 and the microLED display system 160. The second interlayer 140 may include a polymeric material, such as polyurethane, ethylene vinyl acetate, polyvinyl butyral, or some combination thereof. For example, the second interlayer 140 may include polyvinyl butyral. The second interlayer 140 may have a thickness required for the intended application. The second interlayer 140 may have a thickness of about 0.25 mm to about 0.7 mm, or about 0.3 mm to about 0.6 mm.

Referring to FIG. 4, the article 100 may include a painted portion 156. The painted portion 156 may be positioned over at least a portion of the No. 2 surface, the No. 3 surface, or the No. 4 surface. In some non-limiting embodiments, the painted portion 156 may be positioned to cover an area associated with the electronic component 170 associated with the microLED display system 160. In some non-limiting embodiments, the painted portion 156 may be positioned to cover an area associated with the microLED display system 160. The painted portion 156 may be matched to an aesthetic of the microLED display system 160.

The electronic component 170 may include any electrically conductive material suitable for the intended application. The electronic component 170 may include an electronic connector 172 coupled to the microLED display system 160. Further, to support and house the electronic component 170, at least one of the first substrate 110 and the second substrate 120 may define a cavity configured to receive the at least one electronic connector 172.

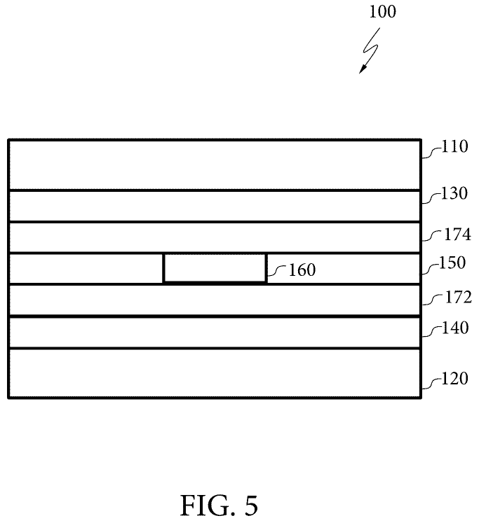

Referring to FIG. 5, the article 100 may include a switchable layer 172. A switchable layer 172 may be any layer that is capable of switching between an activated configuration and a not activated configuration, where when the switchable layer 172 is activated, the transparency of the switchable layer 172 and the article 100 is lowered. The switchable layer 172 may be positioned between the first substrate 110 and the microLED display system 160 (and middle interlayer 150 if present). The switchable layer 172 may be positioned between the second substrate 120 and the microLED display system 160 (and middle interlayer 150 if present). In some non-limiting embodiments, the switchable layer 172 may be positioned between the first substrate 110 and the first interlayer 130. In some non-limiting embodiments, the switchable layer 172 may be positioned between the second substrate 120 and the second interlayer 140. In some non-limiting embodiments, the switchable layer 172 may be positioned between the first interlayer 130 and the microLED display system 160 (and middle interlayer 150 if present). In some non-limiting embodiments, the switchable layer 172 may be positioned between the second interlayer 140 and the microLED display system 160 (and middle interlayer 150 if present), as shown in FIG. 5. In the articles 100 of the present disclosure, when the microLED display system 160 is on, the appearance of the microLED display system 160 is dependent upon the contrast between the microLED display system 160 and the background of the article 100 outside the microLED display system 160 area. When activated, the switchable layer 172 may increase the contrast between the microLED display system 160 and the background compared to the same article 100 where the switchable layer 172 is not activated and/or compared to the same article 100 except without the switchable layer 172, thereby improving the visual aesthetic and viewability of the microLED display system 160. In some non-limiting embodiments, the switchable layer 172 may include a polymer-dispersed liquid crystal (PDLC) layer and/or an electrochromic layer. In some non-limiting embodiments, the switchable layer 172 includes a PDLC layer that includes a black component. Non-limiting examples of PDLC layers that can be used as the switchable layer 172 include those commercially available from TOPPAN Inc. Non-limiting examples of electrochromic layers that can be used as the switchable layer 172 include those commercially available from GENTEX Corporation and/or AMBILIGHT Inc. In some non-limiting embodiments, an adhesive, such as an optically clear adhesive may be provided to bond the switchable layer 172 to the adjacent layers, such as the first interlayer 130, second interlayer 140, and/or microLED display system 160 and middle interlayer 150. The adhesive may be heat curable and/or ultraviolet (UV) curable, or may cure after a period of time. The adhesive may adhere the switchable layer 172 to the microLED display system 160.

Referring further to FIG. 5, the article 100 may include a capacitive touch layer 174. A capacitive touch layer may also be referred to and/or known as a capacitive touch screen, capacitive touch sensor, capacitive switch, and/or a touch sensing layer. The capacitive touch layer 174 may be any layer capable of functioning as a control display for the article 100 and microLED display system 160 and controlled through conductive touch by a user or instrument. In some non-limiting embodiments, the capacitive touch layer 174 may be positioned between the first substrate 110 and the microLED display system 160 (and middle interlayer 150 if present). In some non-limiting embodiments, the capacitive touch layer 174 may be positioned between the second substrate 120 and the microLED display system 160 (and middle interlayer 150 if present). In some non-limiting embodiments, the capacitive touch layer 174 may be positioned between the second substrate 120 and the second interlayer 140. In some non-limiting embodiments, the capacitive touch layer 174 may be positioned between the first substrate 110 and the first interlayer 130. In some non-limiting embodiments, the capacitive touch layer 174 may be positioned between the first interlayer 130 and the microLED display system 160 (and middle interlayer 150 if present), as shown in FIG. 5. In some non-limiting embodiments, the capacitive touch layer 174 may be positioned between the second interlayer 140 and the microLED display system 160 (and the middle interlayer 150 if present). In some non-limiting embodiments, an adhesive, such as an optically clear adhesive may be provided to bond the capacitive touch layer 174 to the adjacent layers, such as the first interlayer 130, second interlayer 140, and/or microLED display system 160 and middle interlayer 150. The adhesive may be heat curable and/or ultraviolet (UV) curable, or mat cure after a period of time. The adhesive may adhere the capacitive touch layer 174 to the microLED display system 160.

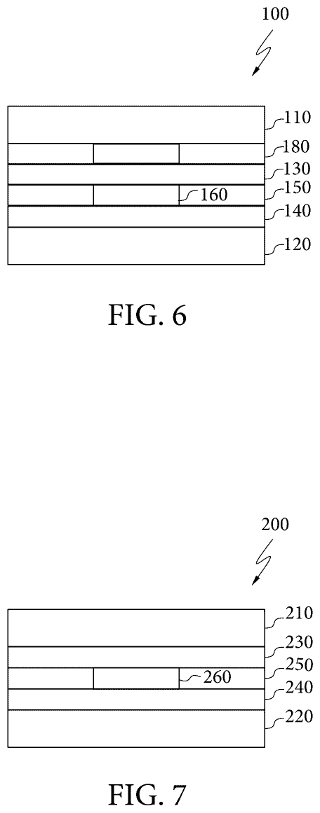

Referring to FIG. 6, the article 100 may include a functional layer 180. A “functional layer”, as used herein, is any layer or combination or layers which imparts a functional benefit to the article 100 beyond decorative purposes. The functional layer 180 may be positioned between the first interlayer 130 and the No. 2 surface of the first substrate 110. In some non-limiting embodiments, the functional layer 180 may include an infrared (IR) reflective coating. For example, the functional layer 180 may include an infrared (IR) reflective coating having at least one infrared (IR) reflective metal layer, such as at least one infrared (IR) reflective metal layer comprising silver. In some non-limiting embodiments, the functional layer 180 may be positioned over the entire No. 2 surface of the first substrate 110 and the first interlayer 130. Alternatively, the functional layer 180 may be positioned over a first portion of the No. 2 surface of the first substrate 110 and the first interlayer 130 and absent over a second portion where the opening 152 is present on the middle interlayer 150.

In some non-limiting embodiments, where the article 100 includes one or more of the first interlayer 130, the second interlayer 140, and the middle interlayer 150, the article 100 may, upon undergoing thermomechanical processing, become a laminated glass article 200. Examples of thermomechanical processing include exposure to elevated temperatures, pressures, and vacuum conditions, such as positioning within an autoclave. In some non-limiting embodiments, the laminated glass article 220 may be an automobile 400 component. In such an example, the materials selected for the laminated glass article are compliant with the requirements under the American National Standard For Safety Glazing Motor Vehicles and Motor Vehicle Equipment Operating On Land Highways ANSI/SAE Z26.

Referring to FIG. 7, disclosed is a laminated glass article 200. The laminated glass article 200 may include a first substrate 210 having a No. 1 surface and a No. 2 surface opposite the No. 1 surface. The first substrate 210 may be the same as the first substrate 110. The laminated glass substrate 200 may include a second substrate 220 opposed from the first substrate 210, the second substrate 220 having a No. 3 surface that faces towards the No. 2 surface, and a No. 4 surface opposite the No. 3 surface. The second substrate 220 may be the same as the second substrate 120.

The laminated glass article 200 may further include a middle interlayer 250 positioned between the first substrate 210 and the second substrate 220. The middle interlayer 250 may be the same as the middle interlayer 150. The middle interlayer 250 may define an opening configured to receive a microLED display system 260. The microLED display system 260 may be the same as the microLED display system 160. The laminated glass article 200 may include a first interlayer 230 positioned between the first substrate 210 and the middle interlayer 250. The first interlayer 230 may be the same as the first interlayer 130. The laminated glass article 200 may include a second interlayer 240 positioned between the second substrate 220 and the middle interlayer 250. The second interlayer 240 may be the same as the second interlayer 140.

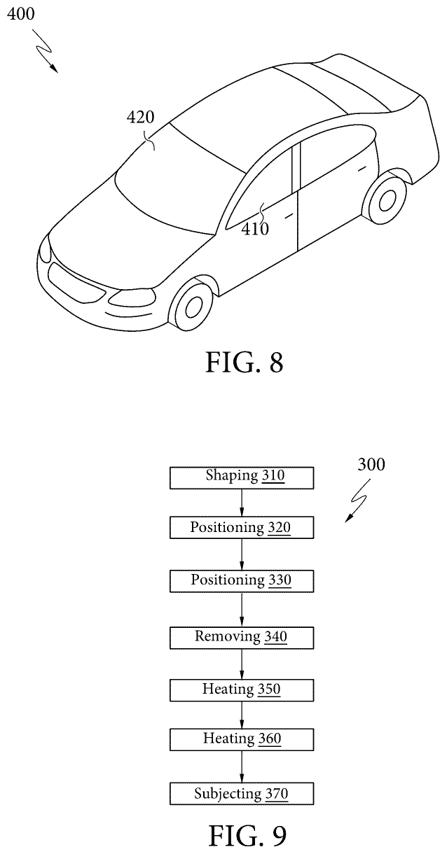

Referring to FIG. 8, disclosed is a vehicle, specifically an automobile 400, having a laminated glass article 200 as shown in FIG. 7. The laminated glass article 200 includes the first substrate 210 having the No. 1 surface and a No. 2 surface opposite the No. 1 surface. The laminated glass article 200 may further include the second substrate 220 opposed from the first substrate 210, the second substrate 220 having a No. 3 surface that faces towards the No. 2 surface, and a No. 4 surface opposite the No. 3 surface.

The laminated glass article 200 further includes the middle interlayer 250 positioned between the first substrate 210 and the second substrate 220. The middle interlayer 250 defines an opening configured to receive the microLED display system 260. The laminated glass article 210 may include the first interlayer 230 positioned between the first substrate 210 and the middle interlayer 250, and the second interlayer 240 positioned between the second substrate and the middle interlayer 250.

In some non-limiting embodiments, the laminated glass article 200 may be a sidelight 410. As used herein, the term “sidelight” refers to the glass window(s) of a vehicle or an automobile 400 located adjacent to the first row of seats, i.e., the driver's row. In some non-limiting embodiments, the laminated glass article 200 may be a windshield 420.

Referring to FIG. 9, disclosed is a method 300 for manufacturing a laminated glass article 200, such as the laminated glass article 200 of FIG. 7. The laminated glass article 200 includes a first substrate 210, a second substrate 220 opposed from the first substrate 210, a first interlayer 230 positioned between the first substrate 210 and the second substrate 220, and a second interlayer 240 positioned between the second substrate 220 and the first interlayer 230. In some non-limiting embodiments, one or more of the first interlayer 230 and the second interlayer 240 include polyurethane. In some non-limiting embodiments, one or more of the first interlayer 230 and the second interlayer 240 include polyvinyl butyral.

The method 300 includes shaping 310 the first substrate 210 including the No. 1 surface and the No. 2 surface, and the second substrate 220 including the No. 3 surface and the No. 4 surface. The first substrate 210 and the second substrate 220 may be shaped to any shape required for the intended application. For example, the first substrate 210 and the second substrate 220 may be shaped to a curvature that corresponds to the curvature of a windshield 420. In another example, the first substrate 210 and the second substrate 220 may be shaped to a curvature that corresponds to a curvature of a sidelight 410. The method 300 may further include, as an optional step, positioning a first interlayer 230 against the No. 2 surface of the first substrate 210.

The method 300 includes positioning 320 a middle interlayer 250 against the first interlayer 230. The middle interlayer 250 may include an opening 252 that is configured to receive a microLED display system 260. In some non-limiting embodiments, the middle interlayer 250 may include polyurethane. In some non-limiting embodiments, the middle interlayer 250 may include polyvinyl butyral.

The method 300 includes positioning 330 the microLED display system 260 in the opening.

The method 300 may further include positioning a second interlayer 240 between the middle interlayer 250 the No. 3 surface, and between the microLED display system 260 and the No. 3 surface. In some non-limiting embodiments, the first substrate 210, the second substrate 220, the middle interlayer 250, and the microLED display system 260 may form a stacked article. In some non-limiting embodiments, the first substrate 210, the second substrate 220, the optional first interlayer 230, the middle interlayer 250, the microLED display system 260, and the optional second interlayer 240 may form a stacked article.

In some non-limiting embodiments, the method 300 may further include positioning the stacked article in an autoclave. Positioning the stacked article in an autoclave allows for exposure to elevated temperatures and pressures in an inert environment simultaneously or sequentially. The positioning in the autoclave may be automated or may be performed manually.

The method 300 further includes removing 340 air, meaning ambient air containing oxygen, from the stacked article for a predetermined period of time. The air may be removed by pulling a vacuum. The predetermined period of time may be about 10 minutes to about 30 minutes. For example, the predetermined period of time may be about 20 minutes.

The method 300 further includes heating 350 the stacked article to a temperature between approximately 200° F. and approximately 300° F., preferably between about 220° F. and about 260° F., for a second predetermined period of time. The second period of time may be about 15 minutes to about 45 minutes. For example, the second predetermined period of time may be about 30 minutes.

The method 300 further includes heating 360 the stacked article to a second temperature between approximately 200° F. and approximately 300° F., preferably about 220° F. to about 290° F., for a third predetermined period of time. The second temperature may be less than the first temperature. The third predetermined period of time may be about 20 minutes to about 40 minutes. For example, the third predetermined period of time may be about 30 minutes.

The method 300 further includes subjecting 370 the stacked article to a pressure between approximately 150 PSI and about 250 PSI, such as about 176 PSI, for a fourth predetermined period of time. The fourth predetermined period of time may be approximately the same as the third predetermined period of time. For example, the heating 360 and the subjecting 370 may be performed concurrently.

### EXAMPLES

The following Examples illustrate various embodiments of the invention. However, it is to be understood that the invention is not limited to these specific embodiments.

### Examples 1-6

### Prophetic Laminated Articles

The following laminated article arrangements have the following sequence of layers, moving from top to bottom of Table 1, and are also within the scope of the present disclosure. These prophetic Examples can be produced according to the method described in FIG. 9.

TABLE 1

| EXAMPLE 1 | EXAMPLE 2 | EXAMPLE 3 |
|---|---|---|
| Glass Substrate | Glass Substrate | Glass Substrate |
| Polyvinyl Butyral Interlayer | Polyvinyl Butyral Interlayer | Polyvinyl Butyral Interlayer |
| Polyvinyl Butyral Interlayer | Polyvinyl Butyral Interlayer | Capacitive Touch Layer |
| with MicroLED Display | with MicroLED Display | |
| | Polyvinyl Butyral Interlayer | Polyvinyl Butyral Interlayer |
| | | with MicroLED Display |
| | Glass Substrate | Switchable Layer |
| | | Polyvinyl Butyral Interlayer |
| | | Glass Substrate |
| EXAMPLE 4 | EXAMPLE 5 | EXAMPLE 6 |
| Glass Substrate | Glass Substrate | Glass Substrate |
| Functional Layer | Polyvinyl Butyral Interlayer | Polyvinyl Butyral Interlayer |
| Polyvinyl Butyral Interlayer | Polyvinyl Butyral Interlayer | Switchable Layer |
| | with MicroLED Display | |
| Polyvinyl Butyral Interlayer | Switchable Layer | Polyvinyl Butyral Interlayer |
| with MicroLED Display | | with MicroLED Display |
| Polyvinyl Butyral Interlayer | Polyvinyl Butyral Interlayer | Polyvinyl Butyral Interlayer |
| Glass Substrate | Glass Substrate | Glass Substrate |

Prophetic Examples 1-6 are expected to produce articles and/or transparent displays using the method(s) described herein that are within the scope of the present disclosure.

It will be readily appreciated by those skilled in the art that modifications may be made to the disclosure without departing from the concepts disclosed in the foregoing description. Accordingly, the particular examples described in detail herein are illustrative only and are not limiting to the scope of the disclosure, which is to be given the full breadth of the appended claims and any and all equivalents thereof.

What is claimed is:

1. An article comprising:
a first substrate comprising a No. 1 surface and a No. 2 surface opposite the No. 1 surface; and
a microLED display system positioned to project light towards the No. 2 surface.

2. The article of claim 1, wherein the microLED display system is coupled with the first substrate.

3. The article of claim 1, wherein the microLED display system has a thickness of approximately 0.1 mm to approximately 0.8 mm.

4. The article of claim 1, further comprising a second substrate opposed from the first substrate, wherein the second substrate comprises a No. 3 surface that faces towards the No. 2 surface, and a No. 4 surface opposite the No. 3 surface, and wherein the microLED display system is positioned between the No. 2 surface and the No. 3 surface.

5. The article of claim 4, further comprising a first interlayer positioned against the No. 2 surface and positioned between the first substrate and the microLED display system.

6. The article of claim 4, further comprising a middle interlayer comprising an opening configured to receive the microLED display system.

7. The article of claim 6, wherein the opening is positioned in a central portion of the middle interlayer.

8. The article of claim 7, wherein the opening is positioned adjacent to an edge portion of the middle interlayer.

9. The article of claim 7, wherein the middle interlayer has a thickness of approximately 0.25 mm to approximately 0.8 mm.

10. The article of claim 7, wherein the middle interlayer comprises polyurethane or polyvinyl butyral.

11. The article of claim 4, wherein at least one of the first substrate and the second substrate comprises soda lime glass.

12. The article of claim 4, further comprising a painted portion positioned over at least a portion of the first substrate or the second substrate, wherein the painted portion covers an area associated with an electronic component associated with the microLED display system.

13. The article of claim 4, further comprising:
a second interlayer positioned between the No. 3 surface and the microLED display system.

14. The article of claim 13, wherein at least one of the first interlayer and the second interlayer comprises polyurethane or polyvinyl butyral.

15. The article of claim 13, wherein the article is a laminated glass article.

16. The article of claim 4, wherein at least one of the first substrate and the second substrate defines a cavity configured to receive at least one electronic connector.

17. The article of claim 1, further comprising an electronic component comprising an electronic connector coupled to the microLED display system.

18. A laminated glass article comprising:
a first glass substrate comprising a No. 1 surface and a No. 2 surface opposite the No. 1 surface;
a second glass substrate opposed from the first glass substrate, wherein the second glass substrate comprises a No. 3 surface that faces towards the No. 2 surface, and a No. 4 surface opposite the No. 3 surface;
a middle interlayer positioned between the first glass substrate and the second glass substrate, the middle interlayer defining an opening configured to receive a microLED display system;
the microLED display system positioned in the opening of the middle interlayer and between the No. 2 surface and the No. 3 surface;
a first interlayer positioned between the first glass substrate and the middle interlayer; and
a second interlayer positioned between the second glass substrate and the middle interlayer.

19. A method for manufacturing a laminated glass article comprising:
shaping a first glass substrate comprising a No. 1 surface and a No. 2 surface, and a second glass substrate comprising a No. 3 surface and a No. 4 surface;
optionally positioning a first interlayer against the No. 2 surface;
positioning a middle interlayer against the first interlayer, wherein the middle interlayer comprises an opening configured to receive a microLED display system;
positioning the microLED display system in the opening;
optionally positioning a second interlayer between the middle interlayer the No. 3 surface, and between the microLED display system and the No. 3 surface, wherein the first glass substrate, second glass substrate, optional first interlayer, middle interlayer, microLED display system and optional second interlayer form a stacked article;
removing air from the stacked article by pulling a vacuum for a predetermined period of time;
heating the stacked article after the air has been removed to a temperature between approximately 200° F. and approximately 300° F. for a second predetermined period of time;
heating the stacked article to a second temperature between approximately 200° F. and approximately 300° F. for a third predetermined period of time; and
subjecting the stacked article to a pressure between approximately 150 PSI and approximately 250 PSI for a fourth predetermined period of time.

20. The method of claim 19, wherein the temperature is between approximately 220° F. and approximately 260° F.
